(19) United States
(12) Patent Application Publication
(10) Pub. No.: US 2011/0278921 A1
(43) Pub. Date: Nov. 17, 2011

(54) Adaptive Power Bus

(76) Inventors: Erik Jon Fretheim, Bellevue, WA (US); Chad Maglaque, Seattle, WA (US)

(21) Appl. No.: 12/777,453

(22) Filed: May 11, 2010

(51) Int. Cl. H02J 3/46; H02J 3/38; G01R 19/00

(52) U.S. Cl. 307/24; 324/76.11; 307/43; 307/18

(57) ABSTRACT

The invention converts the electrical circuitry in a premises for use as an adaptive power bus to which one or more power generating devices may be connected using a standard electrical outlet, without the need for a separate dedicated circuit or any additional electrical wiring and continuing to operate as a traditional power bus, while preventing electrical circuitry from being overloaded.

Embodiments of the adaptive power bus provide the advantage of being able to plug power generating devices directly into a standard electrical outlet without the need for a separate dedicated circuit or any additional electrical wiring, while protecting electrical circuitry from being overloaded by disabling power generating or power consumption devices exactly when needed, and re-enabling power generating and power consumption devices when a circuit overload condition is no longer present. Embodiments of the adaptive power bus allow a premises owners to configure which power generating or power consumption devices to prioritize and which should be turned off or turned down during a circuit overload condition. Embodiments of the adaptive power bus allow power generating devices to be conveniently plugged anywhere within premises, conveniently moved from location to location within premises, or conveniently moved from premises to premises as needed. Embodiments of the adaptive power bus dramatically reduce installation time, installation expense and inspection requirements for a power generating device, thereby lowering the fixed cost and overall pay back period of a power generating device.

### BACKGROUND

Distributed power generation systems such as solar panels, wind turbines, hydro-electric generators, fuel cells, etc. are becoming increasingly popular as a way of supplementing power to premises, and where possible, to sell excess energy back to the local power grid. These distributed generation systems, however, often require a separate dedicated electrical circuit to be added to premises in which they are used. Adding a dedicated electrical circuit is expensive and in some instances may require retrofitting existing electrical wiring, walls, some portion of the premises structure, or the addition of unsightly electrical panels and conduit. This can be particularly challenging if the existing electrical service panel is not conveniently located. At the same time, however, there often already exists several electrical circuits in premises which are used up to their maximum current carrying capacity only a small fraction of the time and which may be more accessed more conveniently than installing a dedicated electrical circuit.

### Safety Considerations

Ideally, premises owners would buy a power generation device, locate a convenient electrical outlet, plug it in, and let the device generate power as needed. Interfering with this goal, however, are safety considerations. First, any power generating device which is capable of feeding power back into the local power grid needs to stop generating power, or be isolated, if the local power grid fails or is shut down. This safety consideration takes into account the safety of line workers working on the local power grid as well as the fact that load placed on the generating device may damage any appliances or electronics devices remaining connected to the generating device through the resulting low voltage (brown-out) condition. Second, any electrical circuit with a power generating device connected to it needs to be protected from excess current. With a dedicated electrical circuit for each power generating source, the current in the circuit is limited to the generation capabilities of the device. However, if a shared electrical circuit is used, then the total current in the electrical circuit will be equal to the sum of the current generated by the power generating device plus current provided from the local power grid. Depending on the configuration of the electrical circuit and the number of devices connected to the electrical circuit, the total current may exceed the rated capabilities of the electrical circuit. If the demand of the power consuming devices on an electrical circuit is less than the rated capacity of the electrical circuit, this is not a problem as the locally produced current will be supplemented with only as much current from the local power grid as is required to meet total demand. If however, power consuming devices are added to the circuit with a total demand greater than the rated capacity of the electrical circuit, the configuration of the electrical circuit will determine if there is a point where the current produced by the power generating device and the current pulled from the local power grid exceed the capacity of the electrical circuit. If such a point exists in the circuit, then there is a danger of overheating, fire, or other mishap. It is these conditions that the adaptive power bus described here prevents.

### SUMMARY

In one aspect, the adaptive power bus includes a electrical circuit, one or more electrical connection points (such as an electrical power outlet, an electric light fixture, etc.) connected to the electrical circuit, a circuit breaker connected to the electrical circuit and which interrupts the flow of electricity within the electrical circuit in the event the total current flowing through the electrical circuit exceeds the rated capacity of the electrical circuit, a circuit monitor which continuously monitors the total current flowing through the electrical circuit, one or more generation controllers operable with one or more power generating devices connected to the electrical circuit and a master controller to monitor the status of the circuit monitor and each generation controller, to communicate with each generation controller to control the amount of power a generating device may generate at any given time and to provide other maintenance functions such as software or firmware updates for the circuit monitor, generation controllers and power generation devices.

In one more aspect, the adaptive power bus may further include one or more consumption controllers operable with one or more power consuming devices connected to the electrical circuit, the status of which is monitored by the master control and with which the master controller communicates to control the amount of power a consuming device may consume at any given time and to provide other maintenance functions such as software or firmware updates for consumption controllers and power consumption devices. Additionally, the adaptive power bus may further include generation and consumption controllers both combined into one or more bi-directional energy flow devices (such battery storage or a flywheel device for storing energy), the status of which is monitored by the master control and with which the master controller communicates to control the amount of power a device may generate or consume at any given time and to provide other maintenance functions such as software or firmware updates.

Additionally, the master controller may monitor the status of the commercial power grid, if the premises are connected to one, and may provide external communication interfaces for monitoring, configuring, maintaining and controlling the adaptive power bus either directly or remotely by the premises owner or a third party (such as a local utility or service provider) communication in order to control the operation or power output of either a power generating device or a power consuming device either individually or as part of a larger power distribution network.

In one further respect, the master controller may control and manage one or more adaptive power buses.

In yet an additional aspect, a method of retrofitting an existing electrical circuit for use as an adaptive power bus (including a plurality of power generating and power consuming devices connected to a common electrical circuit) may include replacing an existing electrical outlet with a hybrid electrical outlet-circuit monitor that fits inside an existing electrical outlet box and is operable with a master controller.

In yet one more aspect, a method of retrofitting an existing electrical circuit for use as an adaptive power bus (including a plurality of power generating and power consuming devices connected to a common electrical circuit) may include replacing an existing circuit breaker with a hybrid circuit breaker-circuit monitor that fits inside an existing circuit breaker slot and is operable with a master controller.

In yet one further aspect, a method of retrofitting an existing electrical circuit for use as an adaptive power bus (including a plurality of power generating and power consuming devices connected to a common electrical circuit) may include replacing an existing electrical outlet with a hybrid electrical outlet-master controller-circuit monitor that fits inside an existing electrical outlet box or replacing an existing circuit breakers with a hybrid circuit breaker-circuit monitor that fits inside a circuit breaker slot of an existing electrical panel and circuit breaker slot.

In at least some implementations, multiple communicatively linked computing devices are used as part of an adaptive power bus. One or more of these computing devices may be communicatively linked in any suitable way such as via one or more networks. One or more networks can include: the Internet, one or more local area networks (LANs), one or more wide area networks (WANs). Network communication may include: wired technologies such as Ethernet, twisted pair, coaxial cable, optical fiber, power line communication (PLC) or wireless technologies such as Wi-Fi/IEEE 802.11x, Bluetooth, Zigbee, WiMAX, General Packet Radio Service (GPRS), EDGE, CDMA, GSM, microwave, infrared or any combination thereof. Additionally, information may be transmitted as a single stream or multiplexed to combine multiple analog message signals or digital data streams into a single signal. And in the event that power line communication is used, the adaptive power bus may further include one or more power line filters to remove any extraneous signals from the power generations bus as needed.

The foregoing summary is illustrative only and is not intended to be in any way limiting. In addition to the illustrative aspects, embodiments, and features described above, further aspects, embodiments, and features will become apparent by reference to the drawings and the following detailed description.

### DESCRIPTION OF THE FIGURES

Various embodiments of the present invention are described herein by way of example in conjunction with the following figures, wherein:

FIG. 1 is a schematic of a typical electrical circuit

FIG. 2 is a schematic of an adaptive power bus with one generation controller and one consumption controller

FIG. 3 is a schematic of a circuit monitor according to various embodiments;

FIG. 4 is a schematic of a generation controller according to various embodiments;

FIG. 5 is a schematic of a consumption controller according to various embodiments;

FIG. 6 is a schematic of a master controller according to various embodiments;

FIG. 7 is a schematic of an adaptive power bus with a plurality of generation controllers connected individually to an electrical connection point;

FIG. 8 is a schematic of an adaptive power bus with a plurality of generation controllers connected to one electrical connection point;

FIG. 9 is a schematic of an adaptive power bus with a plurality of power generation devices connected to one generation controller;

FIG. 10 is a schematic of an adaptive power bus with both a generation controller and a consumption controller combined into the same hybrid power generating-consuming device;

FIG. 11 is a schematic of an adaptive power bus with both the master controller and circuit monitor co-located in the same device;

FIG. 12 is a schematic of an adaptive power bus with both the circuit breaker and circuit monitor co-located in the same device;

FIG. 13 is a schematic of an adaptive power bus with both the master controller and generating controller monitor co-located in the same device;

FIG. 14 is a schematic of two adaptive power buses controlled and managed by a single master controller;

FIG. 15 is a schematic of two adaptive power buses controlled and managed by two independent master controllers;

FIG. 16 is a schematic of a conventional electrical circuit before retrofit according to various embodiments;

FIG. 17 is a schematic of a conventional electrical circuit outlet after retrofit according to various embodiments;

FIG. 18 is a schematic of a conventional electrical circuit before retrofitting an existing electrical outlet according to various embodiments;

FIG. 19 is a schematic of a conventional electrical circuit after retrofitting an existing electrical outlet according to various embodiments;

FIG. 20 is a schematic of a conventional electrical circuit before retrofitting an existing circuit breaker according to various embodiments;

FIG. 21 is a schematic of a conventional electrical circuit after retrofitting an existing circuit breaker according to various embodiments;

FIG. 22 illustrates a computing device according to one embodiment.

### DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The term “power generating device” as used herein, includes without limitation any device (such as a wind turbine, solar panel, hydro-electric generator, battery storage, flywheel or fuel cell) that is able to convert kinetic or potential energy (such as chemical, gravitational, mechanical, nuclear, thermal, optical, EMF, kinematic and sound energy) into electrical energy.

The term “power consuming device” as used herein, includes without limitation any device (such as a motor, light bulb, heater, radio or battery charger, etc.) that uses electrical energy to operate or is able to convert electrical energy into kinetic or potential energy.

The term “daisy chain” as used herein, is a wiring scheme in which, for example, device A is wired to device B, device B is wired to device C, device C is wired to device D, etc. Connections do not form webs (in the preceding example, device C cannot be directly connected to device A), nor do they loop back from the last device to the first.

The term “commercial power feed” as used herein, refers to the primary source of electrical power for the premises. Typically the primary source of a premises' power is from the local electric power grid; however, this is not a requirement for the operation of an adaptive power bus. Premises may operate completely autonomously (also known as” off-grid“) using solar, wind, hydroelectric energy or any other power source, without any reliance on an electrical power grid.

The term “premises” as used herein, includes without limitation any permanent or temporary, stationary or mobile structure used or intended for supporting or sheltering any use or occupancy, and may include without limitation residential homes, commercial buildings, temporary shelters, vehicles, watercraft, airplanes, spacecraft, etc.

The term “electrical circuit” as used herein, refers to a closed loop with one or more component nodes and a return path for electric current to flow to which a number of electrical laws apply, including Kirchoff's Current Law (that is, the sum of all currents entering a node is equal to the sum of all currents leaving the node), Kirchoff's Voltage Law (that is, the directed sum of the electrical potential differences around a loop must be zero) and Ohm's Law (that is, at a constant temperature, the voltage across a resistor is equal to the product of the resistance and the current through it) and through which current may flow in one direction (DC) or may alternate directions (AC) at a given frequency (e.g. 60 Hz AC or 50 Hz AC).

The term “electromagnetic induction” as used herein, refers to the production of voltage across a conductor situated in a changing magnetic field or a conductor moving through a stationary magnetic field.

In general, terms used herein should be read to have their ordinary and common meanings as understood by one of ordinary skill in the art in view of the descriptions provided herein.

A variety of adaptive power bus configurations are described herein. In some embodiments, these configurations may be well-adapted to be installed in homes. In other embodiments, these configurations may be appropriate for use in small, medium or large commercial buildings, temporary shelters, vehicles, etc. In some embodiments, the power generating bus may be an existing electrical circuit, a new electrical circuit, or an electrical cable connection.

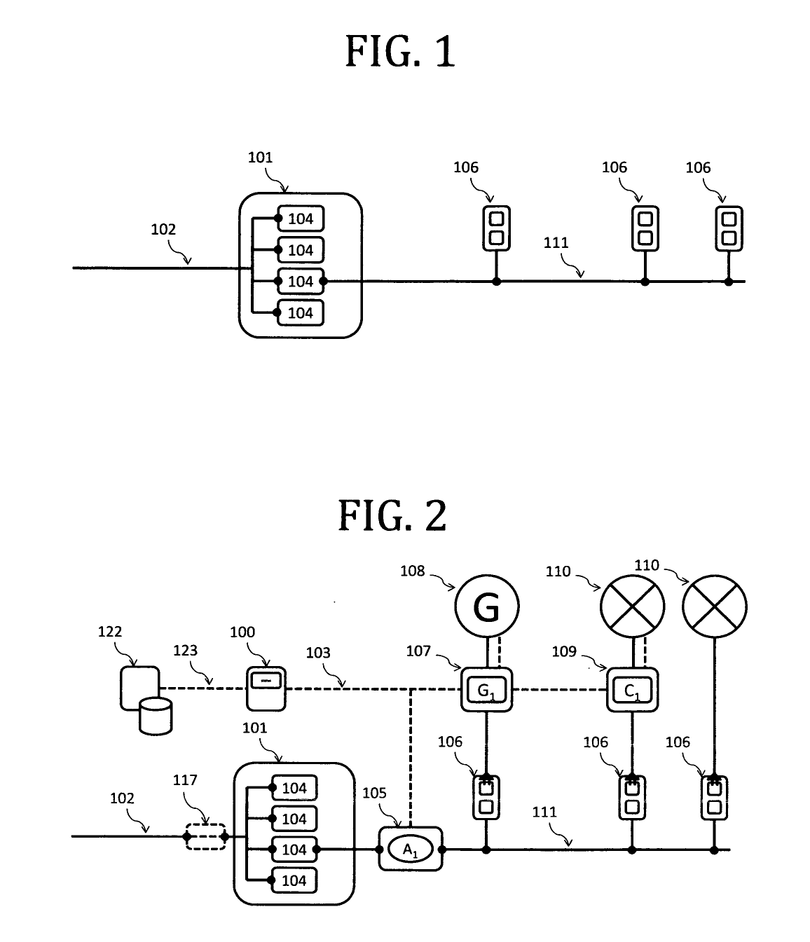

FIG. 1 is a schematic of a typical electrical circuit found in a premises. A commercial power feed 102 from the local power grid is connected to an electric service panel 101 inside of which are connected one or more electrical circuits 111 (only one complete electrical circuit is shown for simplicity). Electrical circuit 111 is connected to the electric service panel 101 via a circuit breaker 104 which interrupts the flow of electricity within the electrical circuit in the event the total current flowing through the electrical circuit 111 exceeds the rated capacity of the electrical circuit 111. Connected to electrical circuit 111 are one or more electrical connection points 106 (such as an electrical power outlet, an electric light fixture, junction box, etc.).

FIG. 2 is a schematic of one embodiment of an adaptive power bus with a single generation controller. A commercial power feed 102 from the local power grid is connected to an electric service panel 101 inside of which are connected one or more electrical circuits 111 (only one complete electrical circuit is shown for simplicity). Electrical circuit 111 is connected to the electric service panel 101 through a circuit breaker 104. Connected to electrical circuit 111 are one or more electrical connection points 106.

Placed at a point between circuit breaker 104 and the first connection point 106 is circuit monitor 105 which monitors the total current A₁ flowing through the electrical circuit 111 and continuously transmits total current flow to master controller 100 on one or more signal channels via communications network 103 at a predetermined frequency sufficient enough to maintain the physical integrity and safety of electrical circuit 111 and the other components of the adaptive power bus.

Placed at a point between electrical connection 106 and power generating device 108 is generating controller 107 which monitors the total current G₁ being generated by power generating device 108 and which transmits generating current flow to master controller 100 on one or more signal channels via communications network 103 at a predetermined frequency sufficient enough to maintain the physical integrity and safety of electrical circuit 111 and the other components of the adaptive power bus. In some embodiments generating controller 107 may be fully operable with power generating device 108 allowing it to transmit operating parameters (such as output voltage, output amps, output power, stored energy, device status, device properties, device temperature, wind speed, wind direction, ambient temperature, ambient pressure, ambient humidity, etc.) to master controller 100.

In one embodiment, a consuming controller 109 may be placed at a point between electrical connection 106 and power consuming device 110 which monitors the total current C₁ being consumed by power consuming device 110 and which transmits consuming current flow to master controller 100 on one or more signal channels via communications network 103 at a predetermined frequency. In some embodiments, consuming controller 109 may be fully operable with power consuming device 110 allowing it to transmit operating parameters (such as input voltage, input amps, input power, stored energy, device status, device properties, device temperature, ambient temperature, ambient pressure, ambient humidity, etc.) to master controller 100.

Connected to circuit monitor 105, generating controller 107, and if present, consuming controller 109 via communications network 103, master controller 100 is able monitor the status of circuit monitor 105, generation controller 107, and if present, consuming controller 109. In the event that the total circuit current A₁ reported by circuit monitor 105 plus the generating current G₁ reported by generating controller 107 together exceed the current rating of electrical circuit 111 (that is A₁₊G₁>Aₘₐₓ) master controller 100 issues a command to generating controller 107 to either turn off power generating device 108 or reduce its output to a level sufficient to eliminate the circuit overload condition. Alternatively, if one or more consuming controllers 109 are present and the consuming current is sufficient to eliminate the circuit overload condition, master controller 100 may issue a command (based on predetermined decision rules, decision rules or preferences set by the premises owner or a third party, device status, local power grid status, energy resource availability, etc.) to consuming controller 109 to either turn off power consuming device 110 or reduce its consumption to a level sufficient to eliminate the circuit overload condition. That is, power generating device 108 may be prioritized above power consuming device 110 and based on predetermined decision rules, decision rules set by the premises owner or a third party, devices properties, device status, local power grid status, stored energy, energy resource availability, etc. power consuming device 110 may be turned off or its consumption reduced to a level sufficient to eliminate the circuit overload condition. Other combinations may also exist where power generating device 108 or power consuming device 110, or any combination thereof, may be turned off or its generation/consumption reduced based on these decision rules.

In one embodiment, to prevent runaway generation the master controller 100 produces one or more continuous digital or analog signals of a predetermined frequency which may be used as a carrier wave for communications and is communicated to each generating controller 107 via communications network 103 and required to be present by all generating controllers 107 in order to have permission to generate power. This, if for some reason, due to a circuit overload condition, a power failure, hardware or software failure in the master controller 100, etc. and this permission-to-generate signal is turned off or not present, any generating controllers 107 synchronized to this signal immediately halt power generation until both the permission-to-generate power signal has been restored and generating controllers 107 have been given explicit command to generate power. Additionally, all power generating devices 108 on the adaptive power bus capable of generating power must have a generating controller 107 capable of monitoring for this permission-to-generate signal and implementing a minimal set of commands received via the communication network 103, including, but not limited to: start/stop power generation, power generating device on/off. In one embodiment, to further prevent runaway generation the circuit monitor 105 produces one or more continuous digital or analog signals of a predetermined frequency communicated to master controller 100 via communications network 103 and is required to be present by master controller 100 in order to generate power over the adaptive power bus. Thus, if for some reason, due to a circuit overload condition, a power failure, hardware or software failure in the circuit monitor 105 and this permission-to-generate signal is turned off or not present, the master controller synchronized to this signal immediately halts all power generation on the adaptive power bus until this permission-to-generate power signal has been restored.

In FIG. 2 and other figures herein the communication network 103 is illustrated as physically separate from an electrical circuit 111. Depending on the embodiment, the electrical circuit 111 can itself be used for communication. Depending on the embodiment, one or more power line filters 117, as illustrated in FIG. 2 and other figures herein, may be placed prior to any point where the communication network 103 is connected to the electrical circuit 111 to remove any extraneous signals from electrical circuit 111.

In addition, the master controller 100 may monitor the status of the commercial power feed 102, if the premises are connected to one, by way of circuit monitor 105 and may provide other maintenance functions such as software or firmware updates for circuit monitor 105, generation controllers 107, power generation devices 108, and if available, consuming controllers 109 and power consuming devices 110.

In one embodiment, the master controller 100 may provide external interfaces for monitoring, logging data, configuring, maintaining and controlling the adaptive power bus and any connected power generating and power consuming devices either directly or remotely by the premises owner or a third party (such as a local utility or service provider) to a management console 122 via a communication network 123. Furthermore, a master controller need not be located in the same location and the adaptive power bus, it only needs to have a direct communication channel with circuit monitor 105, one or more generating controllers 107, and if available, one or more consuming controllers 109.

In order to configure and/or optimize various operational parameters, the user or a third party may connect a computer or other processor-based device to the adaptive power bus via either communication network 123 or communication network 103 and subsequently upload and/or upgrade control parameters of either the master controller 100 or the management console 122, or both.

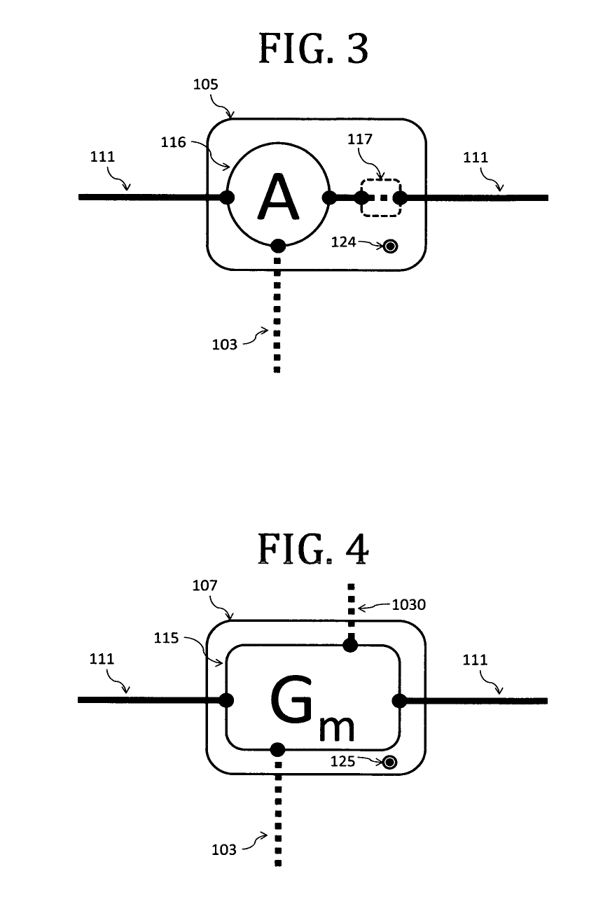

FIG. 3 is a schematic of one embodiment of a circuit monitor 105 including a processor-based meter 116 which monitors the total current flowing through the electrical circuit 111 and continuously transmits total circuit current flow to a master controller 100 on one or more signal channels via communications network 103. Depending on the embodiment, a power line filter 117 may be connected to the electrical circuit 111 to remove any extraneous signals from electrical circuit 111.

In one embodiment, pressing synchronizing button 124 while simultaneously pressing a similar synchronizing button 127 on the master controller 100 (depicted in FIG. 6) opens a synchronization channel between the two devices and synchronizes the two devices with one another via communications network 103, exchanging the device properties of circuit monitor 105 (such as a unique resource identifier, serial number, network address or location, measurement parameters, hardware Build, hardware version, hardware date, firmware version, firmware date, firmware build, encryption keys for secure communication, etc.) with the master controller 100 which in turn records and saves these device properties in non-volatile memory.

In another embodiment, the master controller 100 may monitor communications network 103 to detect the presence a previously unregistered circuit monitor. The circuit monitor can then be configured to work with either the master controller 100 either by a set of pre-configured parameters delivered by the master controller or by exchanging the device properties of circuit monitor 105 and then storing these in non-volatile memory. If the circuit monitor is later to be used with another master controller or adaptive power bus, the stored parameters in non-volatile memory can then be cleared through the use of a reset switch or mechanism.

FIG. 4 is a schematic one embodiment of a generating controller 107 including a processor-based controller 115 which monitors the total current being generated by one or more connected power generating devices (not shown for simplicity) and flowing through the electrical circuit 111 and continuously transmits generating current flow to a master controller 100 on one or more signal channels via communications network 103. As described previously generating controller 107 communicates with master controller 100 to control the amount of power a generating device may generate at any given time and to provide other maintenance functions such as software or firmware updates for consumption controllers and power consumption devices. In some embodiments generating controller 107 may be fully operable with one or more power generating devices via communications network 1030 allowing it to transmit operating parameters (such as output voltage, output amps, output power, stored energy, operational status, device properties, device temperature, wind speed, wind direction, ambient temperature, ambient pressure, ambient humidity, etc.) to master controller 100.

In one embodiment, pressing synchronizing button 125 while simultaneously pressing a similar synchronizing button 124 on the circuit monitor 105 (depicted in FIG. 3) opens a synchronization channel between the two devices and synchronizes the two devices with one another via communications network 103, exchanging a circuit address provided by circuit monitor 105 and the device properties of generating controller 107 (such as a unique resource identifier, serial number, network address or location, power output, power capacity, energy stored, hardware Build, hardware version, hardware date, firmware version, firmware date, firmware build, encryption keys for secure communication, etc.) with circuit monitor 105, both of which in turn record and save these device properties for later operation. In one embodiment, pressing synchronizing button 125 while simultaneously pressing a similar synchronizing button 127 on the master controller 100 (depicted in FIG. 6) opens a synchronization channel between the two devices and synchronizes the two devices with one another via communications network 103, exchanging the circuit address and device properties of generating controller 107 (such as a unique resource identifier, serial number, network address or location, power output, power capacity, energy stored, hardware Build, hardware version, hardware date, firmware version, firmware date, firmware build, encryption keys for secure communication, etc.) with the master controller 100, which in turn records and saves these device properties in non-volatile memory.

In another embodiment, the master controller 100 may monitor communications network 103 to detect the presence of a previously unregistered generating controller. The generating controller can then be configured to work with either the circuit monitor 105 or the master controller 100 either by a set of pre-configured parameters delivered by the master controller or by exchanging the device properties of consuming controller 109 and then storing these in non-volatile memory. If the generating controller is later to be used with another master controller or adaptive power bus, the stored parameters in non-volatile memory can then be cleared through the use of a reset switch or mechanism.

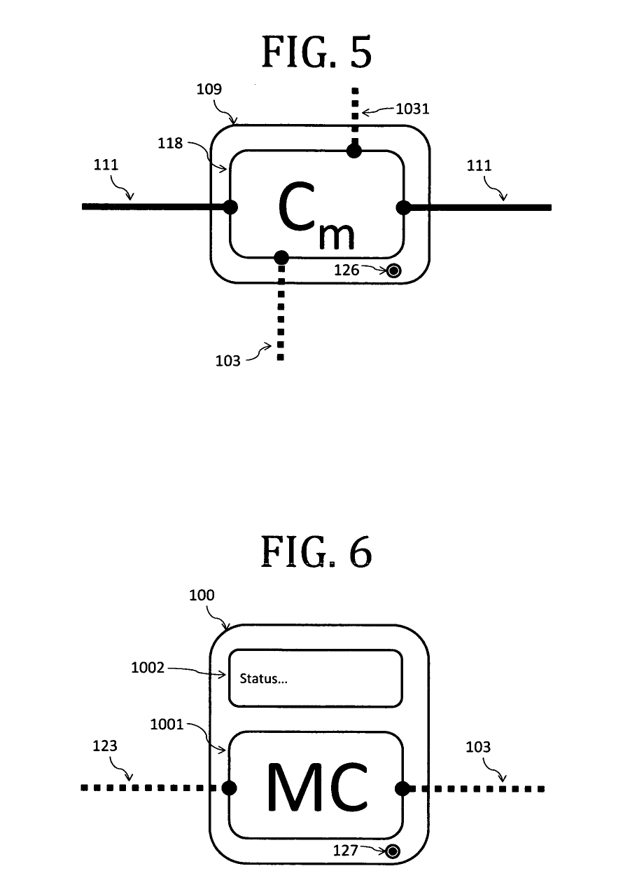

FIG. 5 is a schematic of a consuming controller 109 including a processor-based controller 118 which monitors the total current being consumed by one or more connected power consuming devices (not shown for simplicity) and flowing through the electrical circuit 111 and continuously transmits consuming current flow to a master controller 100 on one or more signal channels via communications network 103. As described, previously consuming controller 109 communicates with master controller 100 to control the amount of power a generating device may consume at any given time and to provide other maintenance functions such as software or firmware updates for consuming controllers and power consumption devices. In some embodiments consuming controller 109 may be fully operable with one or more power consuming devices via communications network 1031 allowing it to transmit operating parameters (such as input voltage, input amps, input power, stored energy, operational status, device properties, device temperature, ambient temperature, ambient pressure, ambient humidity, etc.) to master controller 100.

In one embodiment, pressing synchronizing button 126 while simultaneously pressing a similar synchronizing button 124 on the circuit monitor 105 (depicted in FIG. 3) opens a synchronization channel between the two devices and synchronizes the two devices with one another via communications network 103, exchanging a circuit address provided by circuit monitor 105 and the device properties of consuming controller 109 (such as a unique resource identifier, serial number, network address or location, input power, power capacity, energy stored, hardware Build, hardware version, hardware date, firmware version, firmware date, firmware build, encryption keys for secure communication, etc.) with circuit monitor 105, both of which in turn record and save these device properties in non-volatile memory. In one embodiment, pressing synchronizing button 126 while simultaneously pressing a similar synchronizing button 127 on the master controller 100 (depicted in FIG. 6) opens a synchronization channel between the two devices and synchronizes the two devices with one another via communications network 103, exchanging the device properties of consuming controller 109 (such as a unique resource identifier, serial number, network address or location, input power, power capacity, energy stored, hardware Build, hardware version, hardware date, firmware version, firmware date, firmware build, encryption keys for secure communication, etc.) with the master controller 100, which in turn records and saves these device properties in non-volatile memory.

In another embodiment, the master controller 100 may monitor communications network 103 to detect the presence a previously unregistered consuming controller. The consuming controller can then be configured to work with either the circuit monitor 105 or the master controller 100 either by a set of pre-configured parameters delivered by the master controller or by exchanging the device properties of consuming controller 109 and then storing these in non-volatile memory. If the consuming controller is later to be used with another master controller or adaptive power bus, the stored parameters in non-volatile memory can then be cleared through the use of a reset switch or mechanism.

FIG. 6 is a schematic of one embodiment of a master controller 100 including a processor-based controller 1001 which manages the operation of the power generating bus as described herein via communications network 103. In one embodiment, pressing synchronizing button 127 while simultaneously pressing a similar synchronizing button located on each device in the system opens a synchronization channel between the two devices and synchronizes the two devices with one another as previously described. In one embodiment, master controller may provide a display screen 1002 for displaying information (such as device status, configuration information, network status, error codes, etc). In one embodiment, master controller 100 may provide external interfaces for monitoring, logging data, configuring, maintaining and controlling the adaptive power bus to a management console (not shown for simplicity) via a communication network 123.

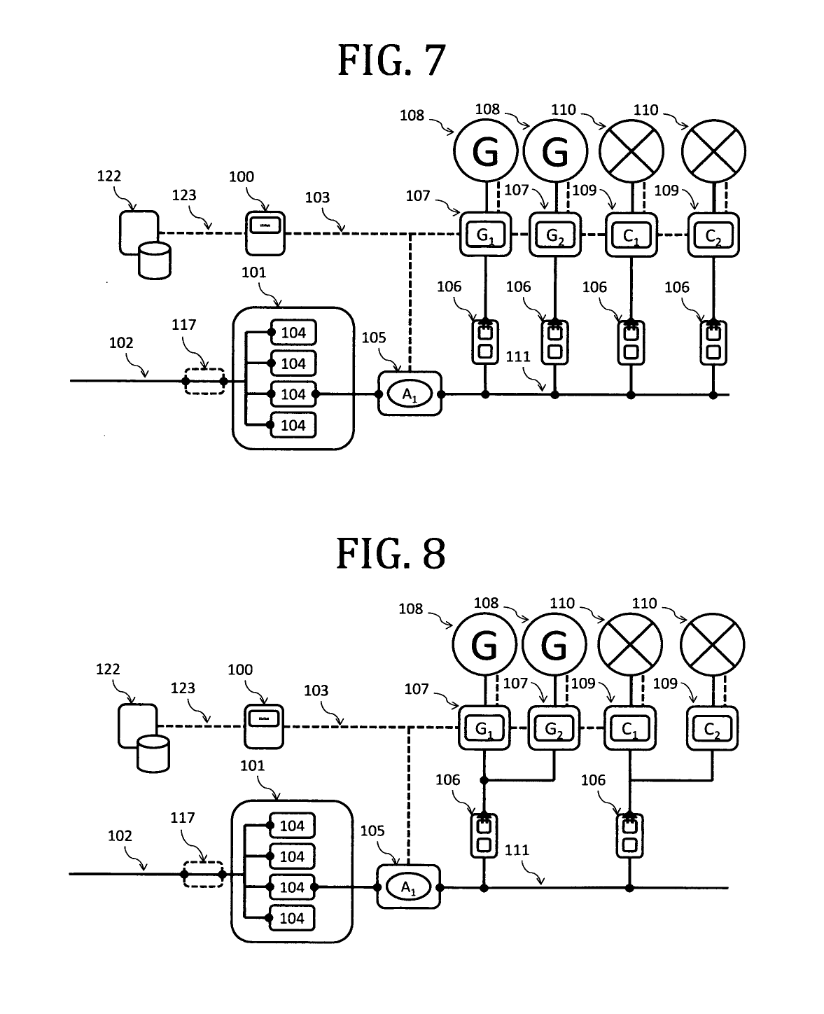

FIG. 7 is a schematic of one embodiment of an adaptive power bus with a plurality of generation controllers connected individually to an electrical outlet. A commercial power feed 102 from the local power grid is connected to an electric service panel 101 inside of which are connected one or more electrical circuits 111 (only one complete electrical circuit is shown for simplicity). Electrical circuit 111 is connected to the electric service panel 101 through a circuit breaker 104. Connected to electrical circuit 111 are one or more electrical connection points 106. Placed at a point between circuit breaker 104 and the first connection point 106 is circuit monitor 105 which monitors the total current A₁ flowing through the electrical circuit 111. Placed at points between one or more electrical connections 106 and one or more power generating devices 108 are generating controllers 107 which monitor the total current G₁, G₂ . . . Gₙ being generated by each power generating device 108. In one embodiment, consuming controllers 109 may be placed at a point between one or more electrical connections 106 and one or more power consuming devices 110 which monitors the total current C₁, C₂ . . . Cₙ being consumed by each power consuming device 110.

In some embodiments one or more generating controllers 107 may be fully operable with power generating devices 108 allowing them to transmit operating parameters (such as output voltage, output amps, output power, stored energy, device status, device properties, device temperature, wind speed, wind direction, ambient temperature, ambient pressure, ambient humidity, etc.) to master controller 100. In some embodiments, one or more consuming controllers 109 may be fully operable with power consuming devices 110 allowing them to transmit operating parameters (such as input voltage, input amps, input power, stored energy, device status, device properties, device temperature, ambient temperature, ambient pressure, ambient humidity, etc.) to master controller 100.

As described herein, master controller 100 is able monitor the status of circuit monitor 105, one or more generation controllers 107, and if present, one or more consuming controllers 109. In the event that the total circuit current A₁ reported by circuit monitor 105 plus the generating current G₁, G₂ . . . Gₙ reported by generating controllers 107 together exceed the current rating of electrical circuit 111 (that is A₁+G₁+G₂ . . . +Gₙ>Aₘₐₓ) master controller 100 issues a command to one or more generating controllers 107 to either turn off power generating devices 108 or reduce their output to a level sufficient to eliminate the circuit overload condition. Alternatively, if one or more consuming controllers 109 are present and the consuming current is sufficient to eliminate the circuit overload condition, master controller 100 may issue a command to one or more consuming controllers 109 to either turn off power consuming devices 110 or reduce their consumption to a level sufficient to eliminate the circuit overload condition. That is, one or more power generating devices 108 may be prioritized above one or more power consuming devices 110, or any combination thereof, and based on predetermined decision rules, decision rules or preferences set by the premises owner or a third party, devices properties, device status, local power grid status, stored energy, energy resource availability, etc. one or more power consuming devices 110 may be turned off or their consumption reduced to a level sufficient to eliminate the circuit overload condition. Other combinations may also exist where one or more power generating devices 108 or power consuming devices 110, or any combination thereof, may be turned off or their generation (or consumption) reduced based on these decision rules.

As described herein, to prevent runaway generation the master controller 100 produce may one or more continuous permission-to-generate signal. If for some reason no permission-to-generate signal is present any generating controllers 107 synchronized to these signals may immediately halt power generation until both the permission-to-generate power signal has been restored and generating controllers 107 have been given explicit command to generate power.

FIG. 8 is a schematic of one embodiment of an adaptive power bus with a plurality of generation controllers connected to the same electrical outlet. A commercial power feed 102 from the local power grid is connected to an electric service panel 101 inside of which are connected one or more electrical circuits 111 (only one complete electrical circuit is shown for simplicity). Electrical circuit 111 is connected to the electric service panel 101 through a circuit breaker 104. Connected to electrical circuit 111 are one or more electrical connection points 106. Placed at a point between circuit breaker 104 and the first connection point 106 is circuit monitor 105 which monitors the total current A₁ flowing through the electrical circuit 111. Placed at points between one or more electrical connections 106 and a plurality of power generating devices 108 are generating controllers 107 which monitor the total current G₁, G₂ . . . Gₙ being generated by each power generating device 108. In one embodiment, consuming controllers 109 may be placed at a point between one or more electrical connections 106 and one or more power consuming devices 110 which monitors the total current C₁, C₂ . . . Cₙ being consumed by each power consuming device 110.

In some embodiments one or more generating controllers 107 may be fully operable with power generating devices 108 allowing them to transmit operating parameters (such as output voltage, output amps, output power, stored energy, device status, device properties, device temperature, wind speed, wind direction, ambient temperature, ambient pressure, ambient humidity, etc.) to master controller 100. In some embodiments, one or more consuming controllers 109 may be fully operable with power consuming devices 110 allowing them to transmit operating parameters (such as input voltage, input amps, input power, stored energy, device status, device properties, device temperature, ambient temperature, ambient pressure, ambient humidity, etc.) to master controller 100.

As described herein, master controller 100 is able monitor the status of circuit monitor 105, a plurality of generation controllers 107, and if present, one or more consuming controllers 109. In the event that the total circuit current A₁ reported by circuit monitor 105 plus the generating current G₁, G₂ . . . Gₙ reported by generating controllers 107 together exceed the current rating of electrical circuit 111 (that is A₁+G₁+G₂ . . . +Gₙ>Aₘₐₓ) master controller 100 issues a command to one or more generating controllers 107 to either turn off power generating devices 108 or reduce their output to a level sufficient to eliminate the circuit overload condition. Alternatively, if one or more consuming controllers 109 are present and consuming current is sufficient to eliminate the circuit overload condition, master controller 100 may issue a command to one or more consuming controllers 109 to either turn off power consuming devices 110 or reduce their consumption to a level sufficient to eliminate the circuit overload condition. That is, one or more power generating devices 108 may be prioritized above one or more power consuming devices 110, or any combination thereof, and based on predetermined decision rules, decision rules set by the premises owner or a third party, devices properties, device status, local power grid status, stored energy, energy resource availability, etc. one or more power consuming devices 110 may be turned off or their consumption reduced to a level sufficient to eliminate the circuit overload condition. Other combinations may also exist where one or more power generating devices 108 or power consuming devices 110, or any combination thereof, may be turned off or their generation/consumption reduced based on these decision rules.

As described herein, to prevent runaway generation the master controller 100 may produce one or more continuous permission-to-generate signal. Thus, if for some reason no permission-to-generate signal is present any generating controllers 107 synchronized to these signals may immediately halt power generation until both the permission-to-generate power signal has been restored and generating controllers 107 have been given explicit command to generate power. To further prevent runaway generation, circuit monitor 105 may also produce one or more continuous digital or analog signals of a predetermined frequency communicated to master controller 100 via communications network 103 and may be required to be present by master controller 100 in order to generate power over the adaptive power bus. Thus, if for some reason no permission-to-generate signal is present, the master controller may immediately halt all power generation on the adaptive power bus until this permission-to-generate power signal has been restored.

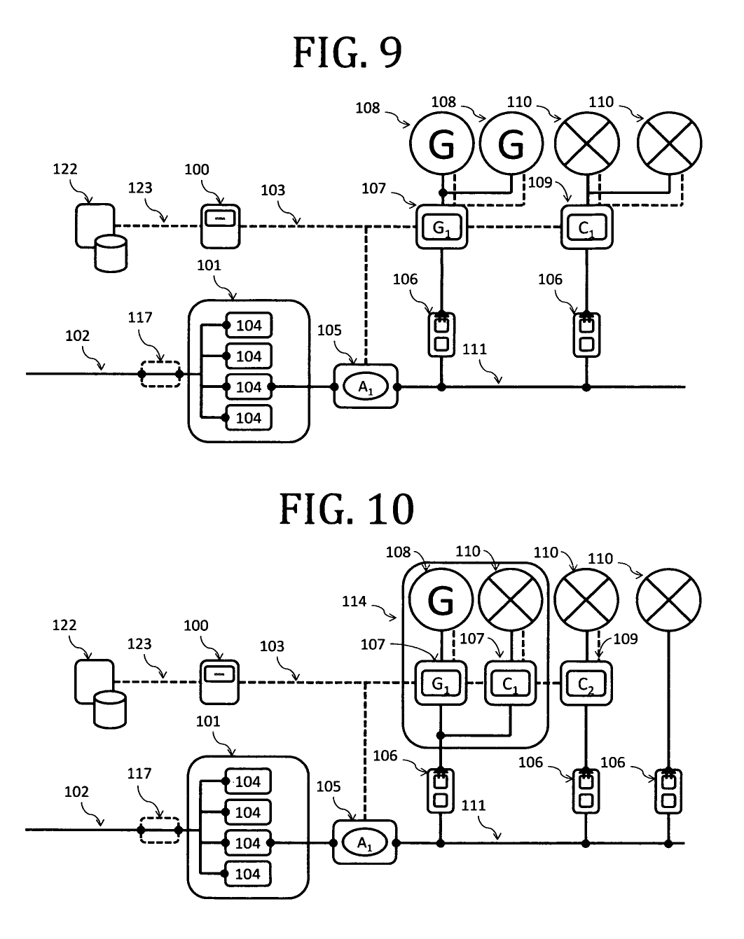

FIG. 9 is a schematic of one embodiment of an adaptive power bus with a plurality of power generation devices in a daisy chain or aggregated through a single generating controller. A commercial power feed 102 from the local power grid is connected to an electric service panel 101 inside of which are connected one or more electrical circuits 111 (only one complete electrical circuit is shown for simplicity). Electrical circuit 111 is connected to the electric service panel 101 through a circuit breaker 104. Connected to electrical circuit 111 are one or more electrical connection points 106. Placed at a point between circuit breaker 104 and the first connection point 106 is circuit monitor 105 which monitors the total current A₁ flowing through the electrical circuit 111. Placed at points between one or more electrical connections 106 and a plurality of power generating devices 108 is generating controller 107 which monitor the total current G₁ being generated by power generating devices 108. In one embodiment, a consuming controller 109 may be placed at a point between one or more electrical connections 106 and one or more power consuming devices 110 which monitors the total current C₁ being consumed by power consuming devices 110.

In some embodiments generating controller 107 may be fully operable with one or more power generating devices 108 allowing it to transmit operating parameters (such as output voltage, output amps, output power, stored energy, device status, device properties, device temperature, wind speed, wind direction, ambient temperature, ambient pressure, ambient humidity, etc.) to master controller 100. In some embodiments, consuming controller 109 may be fully operable with one or more power consuming devices 110 allowing it to transmit operating parameters (such as input voltage, input amps, input power, stored energy, device status, device properties, device temperature, ambient temperature, ambient pressure, ambient humidity, etc.) to master controller 100.

As described herein, master controller 100 is able monitor the status of circuit monitor 105, one or more generation controllers 107, and if present, one or more consuming controllers 109. In the event that the total circuit current A₁ reported by circuit monitor 105 plus the generating current G₁ reported by generating controller 107 together exceed the current rating of electrical circuit 111 (that is A₁+G₁>Aₘₐₓ) master controller 100 issues a command to one or more generating controllers 107 to either turn off power generating devices 108 or reduce their output to a level sufficient to eliminate the circuit overload condition. Alternatively, if one or more consuming controllers 109 are present and consuming current is sufficient to eliminate the circuit overload condition, master controller 100 may issue a command to consuming controller 109 to either turn off power consuming devices 110 or reduce their consumption to a level sufficient to eliminate the circuit overload condition. That is, one or more power generating devices 108 may be prioritized above one or more power consuming devices 110, or any combination thereof, and based on predetermined decision rules, decision rules set by the premises owner or a third party, devices properties, device status, local power grid status, stored energy, energy resource availability, etc. one or more power consuming devices 110 may be turned off or their consumption reduced to a level sufficient to eliminate the circuit overload condition. Other combinations may also exist where one or more power generating devices 108 or power consuming devices 110, or any combination thereof, may be turned off or their generation/consumption reduced based on these decision rules.

As described herein, to prevent runaway generation the master controller 100 may produce one or more continuous permission-to-generate signal. If for some reason no permission-to-generate signal is present any generating controllers 107 synchronized to these signals may immediately halt power generation until both the permission-to-generate power signal has been restored and generating controllers 107 have been given explicit command to generate power. To further prevent runaway generation, circuit monitor 105 may also produce one or more continuous digital or analog signals of a predetermined frequency communicated to master controller 100 via communications network 103 and may be required to be present by master controller 100 in order to generate power over the adaptive power bus. Thus, if for some reason no permission-to-generate signal is present, the master controller may immediately halt all power generation on the adaptive power bus until this permission-to-generate power signal has been restored.

FIG. 10 is a schematic of one embodiment of an adaptive power bus with a generation controller and a consumption controller both combined into the same device (such battery storage or a flywheel device for storing energy). The components and operation of the adaptive power bus assembly are the same as described in the previous embodiments, the only difference being that one or more generation controllers 107 and one or more consumption controllers 109 are combined into the same bi-directional energy flow device 114.

In the various embodiments described herein, the master controller and circuit monitor may be implemented as two units (a processing unit and a current sensing unit) or combined into a single unit—the only requirement is that they have a direct communications channel with one another.

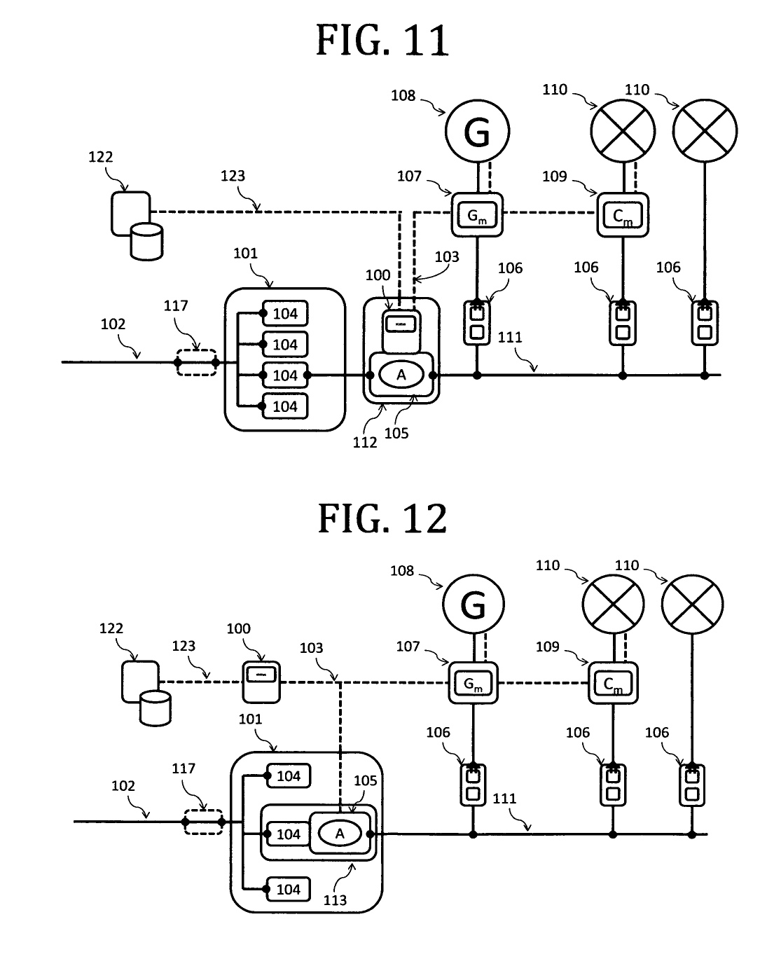

FIG. 11 is a schematic of one embodiment of an adaptive power bus with both the master controller and circuit monitor co-located in the same device. The components and operation of the adaptive power bus assembly are the same as described in the previous embodiments, the only difference being that both the master controller 100 and circuit monitor 105 are co-located in the same device 112.

FIG. 12 is a schematic of one embodiment of an adaptive power bus with both the circuit breaker controller and circuit monitor co-located in the same device. The components and operation of the adaptive power bus assembly are the same as described in the previous embodiments, the only difference being that both the circuit breaker 104 and circuit monitor 105 are co-located in the same device 113.

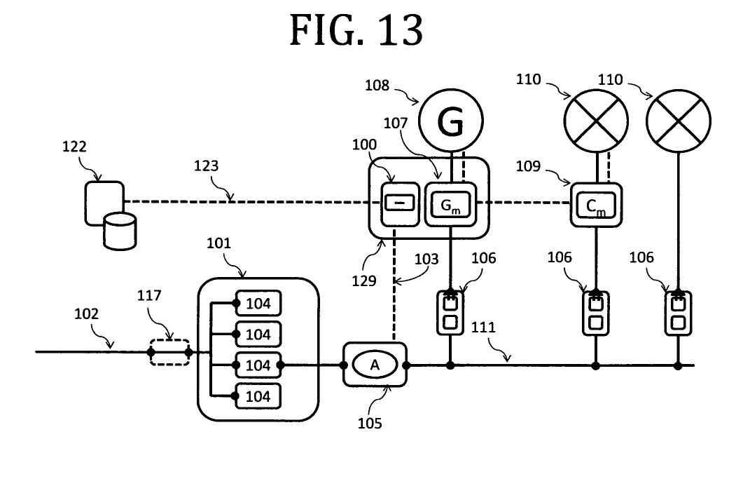

FIG. 13 is a schematic of one embodiment of an adaptive power bus with both the master controller and generating controller co-located in the same device. The components and operation of the adaptive power bus assembly are the same as described in the previous embodiments, the only difference being that both the master controller 100 and generating controller 107 are co-located in the same device 129.

In the various embodiments described herein, a plurality of adaptive power buses may be controlled and managed independently by separate master controllers or by a single master controller—the only requirement is that there be at least one master controller for one or more adaptive power buses.

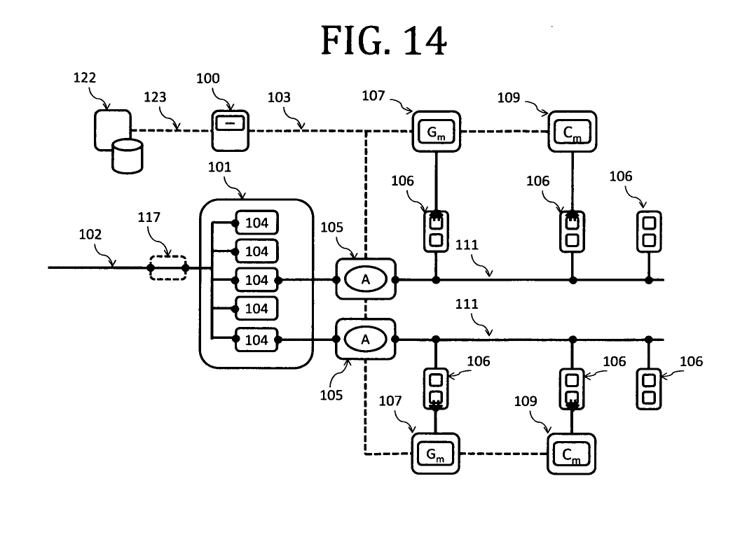

FIG. 14 is a schematic of one embodiment of two adaptive power buses controlled and managed by a single master controller. The components and operation of the adaptive power bus assemblies are the same as described in the previous embodiments, the only difference being that the two adaptive power bus assemblies are addressed by different circuit addresses (as described herein) and managed by a single master controller 100.

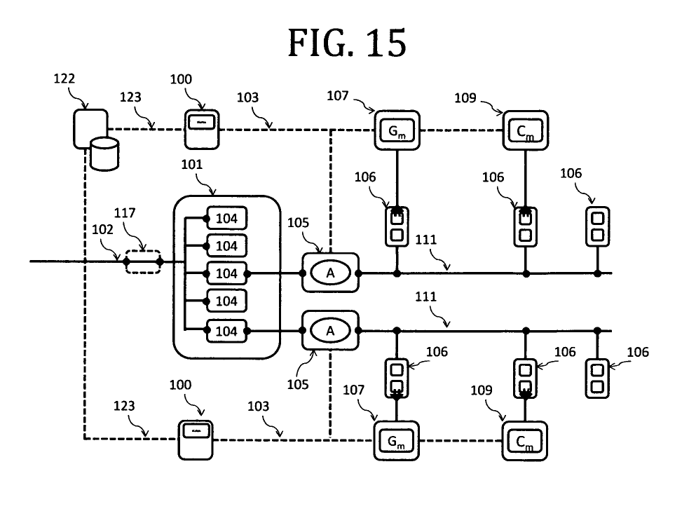

FIG. 15 is a schematic of one embodiment of two adaptive power buses controlled and managed independently by two master controllers. The components and operation of the adaptive power bus assemblies are the same as described in the previous embodiments, the two adaptive power bus assemblies are addressed by different circuit addresses (as described herein) and managed independently by separate master controllers 100.

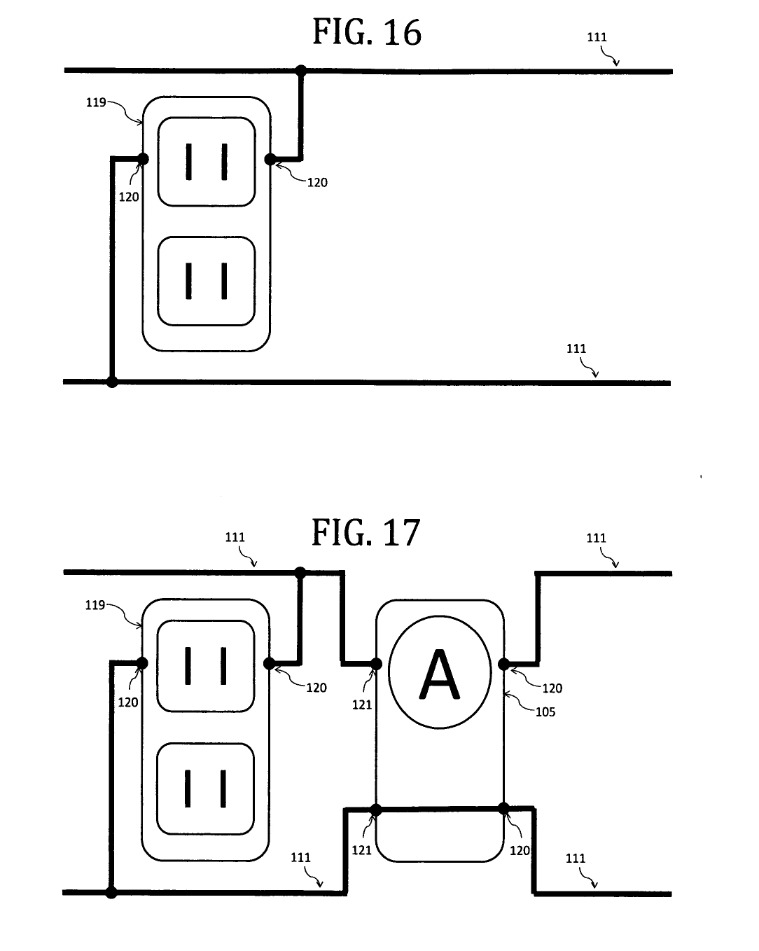

FIG. 16 is a schematic of a one embodiment of a conventional electrical circuit before being retrofitted for use with an adaptive power bus. Before retrofitting, one or more conventional electrical plugs 119 are connected in parallel to electrical circuit 111 via line terminals 120.

FIG. 17 is a schematic of a one embodiment of a conventional electrical circuit after retrofit for use as an adaptive power bus. To retrofit the electrical circuit, electrical circuit 111 is connected to circuit monitor 105 at line terminals 120, physically interrupting electrical circuit 111. In the illustrated embodiment, the remaining portion of electrical circuit 111 is then connected to the circuit monitor 105 at load terminals 121, with one or more conventional electrical plugs 119 then connected in parallel to electrical circuit 111 via line terminals 120. In some embodiments, circuit monitor 105 may fit inside an existing or newly electrical junction box.

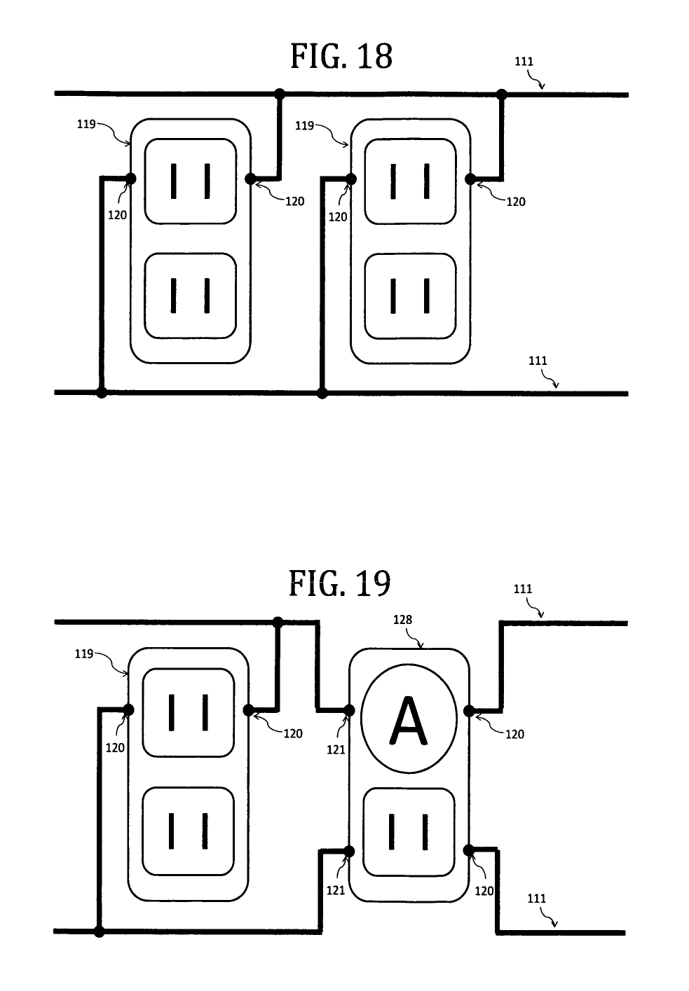

FIG. 18 is a schematic of a further embodiment of a conventional electrical circuit before being retrofitted for use with an adaptive power bus. Before retrofitting, conventional electrical plugs 119 are connected in parallel to electrical circuit 111 via line terminals 120 and fit inside an existing electrical outlet box.

FIG. 19 is a schematic of a further embodiment of a conventional electrical circuit after retrofit for use as an adaptive power bus. To retrofit the electrical circuit, a conventional electrical plug is replaced by hybrid electrical outlet-circuit monitor 128 is connected to electrical circuit 111 at line terminals 120, physically interrupting electrical circuit 111. In the illustrated embodiment, the remaining portion of electrical circuit 111 is then connected to the hybrid electrical outlet-circuit monitor at load terminals 121, with one or more conventional electrical plugs 119 then connected in parallel to electrical circuit 111 via line terminals 120. In some embodiments, a hybrid electrical outlet-circuit monitor 128 may fit inside the existing electrical outlet box of the replaced electrical outlet.

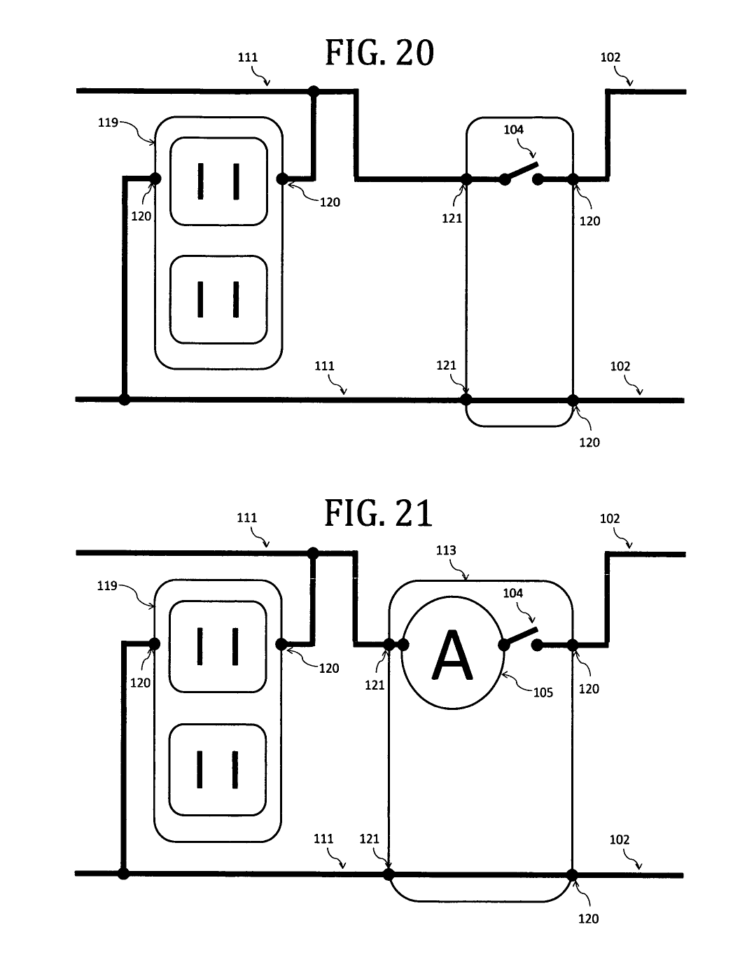

FIG. 20 is a schematic of yet another embodiment of a conventional electrical circuit before being retrofitted for use with an adaptive power bus. Before retrofitting, electrical circuit 111 is connected to circuit breaker 104 at load terminals 121 and commercial power feed 102 is connected to circuit breaker 104 at line terminals 120 inside a conventional electrical panel (electrical panel not shown for simplicity), physically interrupting electrical circuit 111 from commercial power feed 102. In the illustrated embodiment, one or more conventional electrical plugs 119 are connected in parallel to the remaining portion of electrical circuit 111 via line terminals 120.

FIG. 21 is a schematic of yet another embodiment of a conventional electrical circuit after retrofit for use as an adaptive power bus. To retrofit the electrical circuit, electrical circuit 111 is connected to a hybrid circuit breaker-circuit monitor 113 at load terminals 121 and commercial power feed 102 is connected to circuit breaker-circuit monitor 113 at line terminals 120 inside a conventional electrical panel (not shown for simplicity), physically interrupting electrical circuit 111 from commercial power feed 102. In the illustrated embodiment, one or more conventional electrical plugs 119 remain connected in parallel to the remaining portion of electrical circuit 111 via line terminals 120. In some embodiments, a hybrid circuit breaker-circuit monitor 113 may fit inside the existing circuit breaker slot of the replaced circuit breaker.

The Figures depict several different electrical wiring configurations. Some embodiments may include a circuit isolation switch at the current monitoring point, or at any other point after the commercial power feed enters the premises which can be used to electrically isolate the premises' electrical wiring, a portion of the premises' electrical wiring or a limited number of circuits from the commercial power grid in the event of failure of the commercial power grid or other event.

The Figures depict several different configurations of single or dual generation and consumption controllers. In some embodiments, an adaptive power bus may include a one or more generation and consumption controllers, which may be of the same or of different types. Generation and consumption controllers may operate independently, or may be operatively coupled. In particular, an adaptive power bus may include control electronics that select whether to operate a power generating or power consumption device, and which power generating or power consumption device to operate, in response to a determined actual or predicted operating condition. For example, when one or more power consumption devices are not in demand, the control electronics may disable one or more of these power consumption devices instead of power generating devices, or some combination thereof.

Although control of the adaptive power bus in above-described embodiments is performed locally by the processor-based master controller 100, it will be appreciated that in other embodiments such control may be provided by one or more remotely-located control devices (e.g., remotely-located processor based controller(s)) operated by a third party and/or associated with a distributed power management system comprising a plurality of controllable power resources. Furthermore, a master controller need not be located in the same location as the adaptive power bus, it only needs to have a direct communication channel with the adaptive power bus—that is one or more circuit monitors 105, generating controllers 107 and consuming controllers 109.

Those skilled in the art will recognize that methods for measuring electrical current include, but are not limited in any way to, physically interrupting an electrical circuit and inserting a measuring device directly into the electrical circuit, placing the measuring device in sufficient proximity to an electrical circuit to measure current using electromagnetic induction or other means.

It will be appreciated by one of ordinary skill in the art that at least some of the embodiments described herein or parts thereof may be implemented using hardware, firmware and/or software. The firmware and software may be implemented using any suitable computing device(s). FIG. 22 shows an example of a computing device 1200 according to one embodiment that may be used for implementing the processor-based master controller 100, circuit monitor 105, generating controller 107, consuming controller 109 and management console 122. For the sake of clarity, the computing device 1200 is illustrated and described here in the context of a single computing device. However, it is to be appreciated and understood that any number of suitably configured computing devices 1200 can be used to implement any of the described embodiments. It also will be appreciated that one such device or multiple devices may be shared in a time division multiplex mode among compensators for multiple power amplifiers, as may be the case, for example, in a base station of a mobile communication network. For example, in at least some implementations, multiple communicatively linked computing devices 1200 are used. One or more of these devices may be communicatively linked in any suitable way such as via one or more networks. One or more networks can include, without limitation: the Internet, one or more local area networks (LANs), one or more wide area networks (WANs) or any combination thereof. Network communication may include, without limitation: wired technologies such as Ethernet, twisted pair, coaxial cable, optical fiber, power line communication (PLC) or wireless technologies such as Wi-Fi/IEEE 802.11x, Bluetooth, Zigbee, WiMAX, General Packet Radio Service (GPRS), EDGE, CDMA, GSM, microwave, infrared or any combination thereof. Additionally, information may be transmitted as a single stream or multiplexed to combine multiple analog message signals or digital data streams into a single signal.

In this example, the computing device 1200 may comprise one or more processor circuits or processing units 1202, one or more memory circuits and/or storage circuit component(s) 1204 and one or more input/output (I/O) circuit devices 1206. Additionally, the computing device 1200 comprises a bus 1208 that allows the various circuit components and devices to communicate with one another. The bus 1208 represents one or more of any of several types of bus structures, including a memory bus or memory controller, a peripheral bus, an accelerated graphics port, and a processor or local bus using any of a variety of bus architectures. The bus 1208 may comprise wired and/or wireless buses.

The processing unit 1202 may be responsible for executing various software programs such as system programs, applications programs, and/or program modules/blocks to provide computing and processing operations for the computing device 1200. The processing unit 1202 may be responsible for performing various voice and data communications operations for the computing device 1200 such as transmitting and receiving voice and data information over one or more wired or wireless communications channels. Although the processing unit 1202 of the computing device 1200 is shown in the context of a single processor architecture, it may be appreciated that the computing device 1200 may use any suitable processor architecture and/or any suitable number of processors in accordance with the described embodiments. In one embodiment, the processing unit 1202 may be implemented using a single integrated processor.

The processing unit 1202 may be implemented as a host central processing unit (CPU) using any suitable processor circuit or logic device (circuit), such as a as a general purpose processor. The processing unit 1202 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 1202 may be coupled to the memory and/or storage component(s) 1204 through the bus 1208. The bus 1208 may comprise any suitable interface and/or bus architecture for allowing the processing unit 1202 to access the memory and/or storage component(s) 1204. Although the memory and/or storage component(s) 1204 may be shown as being separate from the processing unit 1202 for purposes of illustration, it is worthy to note that in various embodiments some portion or the entire memory and/or storage component(s) 1204 may be included on the same integrated circuit as the processing unit 1202. Alternatively, some portion or the entire memory and/or storage component(s) 1204 may be disposed on an integrated circuit or other medium (e.g., hard disk drive) external to the integrated circuit of the processing unit 1202. In various embodiments, the computing device 1200 may comprise an expansion slot to support a multimedia and/or memory card, for example.

The memory and/or storage component(s) 1204 represent one or more computer-readable media. The memory and/or storage component(s) 1204 may be implemented using any computer-readable media capable of storing data such as volatile or non-volatile memory, removable or non-removable memory, erasable or non-erasable memory, writeable or re-writeable memory, and so forth. The memory and/or storage component(s) 1204 may comprise volatile media (e.g., random access memory (RAM)) and/or nonvolatile media (e.g., read only memory (ROM), Flash memory, optical disks, magnetic disks and the like). The memory and/or storage component(s) 1204 may comprise fixed media (e.g., RAM, ROM, a fixed hard drive) as well as removable media (e.g., a Flash memory drive, a removable hard drive, an optical disk). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 1206 may allow a user to enter commands and information to the computing device 1200, and also may allow information to be presented to the user and/or other components or devices. Examples of input devices include data ports, ADCs, DACs, a keyboard, a cursor control device (e.g., a mouse), a microphone, a scanner and the like. Examples of output devices include data ports, ADCs, DACs, a display device (e.g., a monitor or projector, speakers, a printer, a network card). The computing device 1200 may comprise an alphanumeric keypad coupled to the processing unit 1202. The keypad may comprise, for example, a QWERTY key layout and an integrated number dial pad. The computing device 1200 may comprise a display coupled to the processing unit 1202. The display may comprise any suitable visual interface for displaying content to a user of the computing device 1200. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 1202 may be arranged to provide processing or computing resources to the computing device 1200. For example, the processing unit 1202 may be responsible for executing various software programs including system programs such as operating system (OS) and application programs. System programs generally may assist in the running of the computing device 1200 and may be directly responsible for controlling, integrating, and managing the individual hardware components of the computer system. The OS may be implemented, for example, as a Microsoft® Windows OS, Symbian OSTM, Embedix OS, Linux OS, Binary Run-time Environment for Wireless (BREW) OS, Java OS, or other suitable OS in accordance with the described embodiments. The computing device 1200 may comprise other system programs such as device drivers, programming tools, utility programs, software libraries, application programming interfaces (APIs), and so forth.

Various embodiments may be described herein in the general context of computer executable instructions, such as software or program modules/blocks, being executed by a computer. Generally, program modules/blocks include any software element arranged to perform particular operations or implement particular abstract data types. Software can include routines, programs, objects, components, data structures and the like that perform particular tasks or implement particular abstract data types. An implementation of these modules/blocks or components and techniques may be stored on some form of computer-readable media. In this regard, computer-readable media can be any available medium or media used to store information and accessible by a computing device. Some embodiments also may be practiced in distributed computing environments where operations are performed by one or more remote processing devices that are linked through a communications network. In a distributed computing environment, program modules/blocks may be located in both local and remote computer storage media including memory storage devices.

Although some embodiments may be illustrated and described as comprising functional component or modules/blocks performing various operations, it can be appreciated that such components or modules/blocks may be implemented by one or more hardware components, software components, and/or combination thereof. The functional components and/or modules/blocks may be implemented, for example, by logic (e.g., instructions, data, and/or code) to be executed by a logic device (e.g., processor). Such logic may be stored internally or externally to a logic device on one or more types of computer-readable storage media. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSPs), field programmable gate array (FPGA), logic gates, registers, semiconductor devices, chips, microchips, chip sets, and so forth. Examples of software may include software components, programs, applications, computer programs, application programs, system programs, machine programs, operating system software, middleware, firmware, software modules/blocks, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

It also is to be appreciated that the described embodiments illustrate example implementations, and that the functional components and/or modules/blocks may be implemented in various other ways which are consistent with the described embodiments. Furthermore, the operations performed by such components and/or modules/blocks may be combined and/or separated for a given implementation and may be performed by a greater number or fewer number of components and modules/blocks.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a generation controller” should typically be interpreted to mean “at least one generation controller”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two generation controllers,” or “a plurality of generator controllers,” without other modifiers, typically means at least two generator controllers). Furthermore, in those instances where a phrase such as “at least one of A, B, and C,”“at least one of A, B, or C,” or “an [item] selected from the group consisting of A, B, and C,” is used, in general such a construction is intended in the sense one having skill in the art would understand the convention (e.g., any of these phrases would include but not be limited to systems that have A alone, B alone, C alone, A and B together, A and C together, B and C together, and/or A, B, and C together). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting and it is therefore to be understood that the appended claims are intended to cover all such modifications and changes as fall within the scope of the embodiments.

1. An adaptive power bus comprising: an electrical circuit; a first circuit monitor located at any point between a first circuit breaker and a first connection point on a first electrical circuit and which monitors the total current flowing through the first electrical circuit; and a first master controller connected to the first circuit monitor via a first communications network.

2. The adaptive power bus of claim 1 further comprising a second circuit monitor located at any point between a second circuit breaker and a second connection point on an second electrical circuit, and which monitors the total current flowing through the second electrical circuit and is connected to the first master controller via a first communications network

3. The adaptive power bus of claim 1 further comprising one or more generating controllers connected to either a first or second electrical circuit and to one or more associated power generating devices, and which monitor the total current generated by one or more associated power generation devices and are connected to a first master controller via a first communications network.

4. The adaptive power bus of claim 1 further comprising one or more consumption controllers connected to either a first or second electrical circuit and one or more associated power consuming devices, and which can monitor the current consumed by one or more associated power consuming devices and are connected to a first master controller via a first communications network.

5. The adaptive power bus in claim 1, further comprising generation and consumption controllers combined into one or more bi-directional energy flow devices connected to either a first or second electrical circuit and one or more associated hybrid power generating-consuming devices, and which can monitor the current generated or consumed by one or more associated hybrid power generating-consuming devices and are connected to a first master controller via a first communications network.

6. The adaptive power bus in claim 1 further comprising one or more generating controllers connected via a first communications network to one or more associated power generating devices allowing the generating controller to transmit associated power generating device parameters to a first master controller.

7. The adaptive power bus in claim 1 further comprising one or more consuming controllers connected via a first communications network to one or more associated power consuming devices allowing the consuming controller to transmit associated power consuming device parameters to a master controller.

8. The adaptive power bus in claim 1 further comprising one or more associated power generating devices connected via a first communications network allowing the associated power generating device to transmit device parameters to a first master controller.

9. The adaptive power bus in claim 1 further comprising one or more associated power consuming devices connected via a first communications network allowing the associated power consuming device to transmit device parameters to a first master controller.

10. The adaptive power bus in claim 1, further comprising a management console connected to one or more master controllers via a communications network which allows a user or third party to configure and/or optimize a set of decision rules used by a master controller to issue commands to one or more generating controllers or, if present, to one or more consuming controllers.

11. The adaptive power bus in claim 1, further comprising a master controller which allows a user or third party to configure and/or optimize a set of decision rules used by the master controller to issue operational commands to one or more generating controllers or, if present, to one or more consuming controllers.

12. A method of operating an adaptive power bus including an electrical circuit, a circuit monitor located at any point between a circuit breaker and a first connection point on the electrical circuit and which monitors the total current flowing through the electrical circuit, one or more generating controllers connected to a connection point on the electrical circuit and one or more power generating devices which monitor the total current generated by one or more power generation devices, a master controller connected to one or more circuit monitors and one or more generating controllers via a communications network, the method comprising: monitoring the status of the circuit monitor, one or more generation controllers, and if present, one or more consuming controllers. In the event that the total circuit current reported by the circuit monitor plus the generating current reported by generating controllers together exceed the current rating of electrical circuit, the master controller issues a command based on a set of decision rules to either one or more generating controllers or, if present, to one or more consuming controllers, or any combination thereof, to either turn off power generating or consuming devices or reduce their generating output or consumption to a level sufficient to eliminate the circuit overload condition.

13. The method of claim 12, further comprising the generation of one or more continuous permission-to-generate signals by a master controller, the absence of which forces any generating controllers synchronized to the master controller to immediately halt power generation until a permission-to-generate power signal has been restored.

14. The method of claim 12, further comprising the generation of one or more continuous permission-to-generate signals by a circuit monitor, the absence of which forces the master controller to immediately halt power generation until the permission-to-generate power signal has been restored.

15. The method of claim 12, further comprising a management console connected to one or more master controllers via a communications network, the method comprising setting decision rules used by a master controller to issue commands to one or more generating controllers or, if present, to one or more consuming controllers, or any combination thereof, to either turn off power generating or consuming devices or reduce their generating output or consumption.

16. A method of synchronizing each of the components of an adaptive power bus including one or more circuit monitors, one or more generating controllers, one or more power generating devices, one or more consuming controllers, one or more power consuming devices and one or more master controllers via a communications network, the method comprising: associating one or more power generating devices with a generating controller, associating one or more power consuming devices with a consuming controller, associating one or more generating controllers with a circuit monitor, associating one or more consuming controllers with a circuit monitor, associating one or more generating controllers with a master controller, associating one or more consuming controllers with a master controller, and one or more circuit monitors with a master controller and exchanging device properties including unique resource identifier, serial number, network address or location, circuit address, hardware build, hardware version, hardware date, firmware version, firmware date, firmware build and encryption keys for secure communication and saving these device properties in non-volatile memory.
